(19) United States
(12) Patent Application Publication
(10) Pub. No.: US 2004/0105395 A1
(43) Pub. Date: Jun. 3, 2004

(54) Method and device for providing conferences

(76) Inventors: Peter Friedrich, Petershagen (DE); Nobert Lobig, Darmstadt (DE)

Correspondence Address: MORRISON & FOERSTER LLP, 1650 TYSONS BOULEVARD, SUITE 300, MCLEAN, VA, 22102, US

(21) Appl. No.: 10/644,078

(22) Filed: Aug. 20, 2003

(30) Foreign Application Priority Data
Aug. 21, 2002 (DE) 10238285.9

(51) Int. Cl. H04Q 11/00

(52) U.S. Cl. 370/261

(57) ABSTRACT

A control interface and method between an announcement/dialog function with voice recognition functionality and a conference management function, via which the conference can be initiated and controlled during its course. The conference management function receives the characteristic data of relevance to the conference in its dialog with the conference leader and the conferees via the announcement/dialog function, reserves the corresponding resources in advance and has direct access via a further interface to the conference control functions, which can also be influenced during the conference in dialog with the conferees.

### CLAIM FOR PRIORITY

This application claims priority to German application 10238285.9, which was filed in the German language on Aug. 21, 2002, the contents of which are hereby incorporated by reference.

### TECHNICAL FIELD OF THE INVENTION

The invention relates to a method and a device for providing conferences, and in particular, to a control interface between an announcement/dialog function with voice recognition functionality and a conference management function.

### BACKGROUND OF THE INVENTION

With the prior art, services for audio conferences are part of the essential range of services offered by voice switching networks. They are provided by the switching centers of the network or even by network elements external to the switching centers. The conference function here is based on a combined function for the audio stream of the participating conferees, which is provided by a specific hardware unit with DSP capacity (Digital Signal Processor).

In conventional cases, where the useful channel of a connection is fed to the switching center, the conference functions and the announcement and tone functions required for these can be provided by peripheral devices or external devices equipped with corresponding functionality. If however the useful data is conveyed outside the switching center in a packet network, preferably at least one external conference system is used for this. The system has interfaces with the packet network for the useful data of the conference. The useful data of the conference here is either the useful data of the individual conferees or the announcements/dialogs and tones to be input as well as the combined signal to be distributed to the conferees, which is generated via at least one conference bridge. The external conference system can also have a control interface with the switching center controlling connections in the packet network conveyed outside the switching center, in order to control the required basic functions during the conference or to initiate the interspersion of announcements/dialogs and tones generated in the external conference system for example.

Conference services have a range of conference features, which can be differentiated and defined with respect to the initiation and control of the progress of the conference:

There are, on the one hand, conference features with which users are included as participants by DIAL-IN (dialing of the conferee into the conference) or by DIAL-OUT (calling of the conferee out of the conference), i.e. the conference process is characterized by the availability of the conferees (e.g. by connecting participants to the conference or the departure of participants from the conference).

On the other hand, there are conference features which are characterized by the conference leader or the conferees of the controlled conferences. For example, conferees can be connected, switched to silent or disconnected from the conference by a conference leader by means of appropriate DSS1 signaling (ETSI ADD-ON conference) or via an additional graphic control system on a PC-type terminal. These conference features controlling the conference are often available to the Conference Service Operator, who can manage the conference resources in the network and monitor the conference service.

With regard to videoconferences, which are increasingly used in packet-based networks, the need for conference control is increased by the participating conferees, who increasingly wish to influence the image to be viewed. This includes the selection of one or more participants during the conference, voice-activated switching of the image to the conferees speaking at the time, simultaneous image availability for a certain number of conferees and the additional insertion of documents.

Conversely, existing conference solutions inform the participants currently in a conference about the inclusion of a further conferee in the conference or the fact that a conferee has left the conference by means of conference tones and/or by means of generally few conference announcements of corresponding content.

With regard to the initiation and control of conferences, the following distinction is made between conference services:

With the ETSI-ADD-ON conference, control is by definition only possible in a local switching center. It is initiated and controlled via conferee signaling (numerical sequence control). It is primarily available in TDM-based but also in packet-based networks, the switching centers of which support conventional participant signaling and can be initiated directly (AD HOC).

The PRESET conference represents a compromise between AD HOC initiation and a simultaneously predefined conferee list.

The PHONEMEET conference is offered as a general network service (public conference). This service, which is very similar to the internet chat service but is much longer established, provides a Service Code, which can be used to dial into a conference on a specific topic and have discussions with conferees who have already dialed into the topic. Conferees do not generally identify themselves and have no guarantee that they will be connected to a repeat joint conference when they dial in again. The characterizing feature of such a service is that participants, who generally do not know each other, can have discussions in the public network. No control by conferees is required here and automatic monitoring of disruptive parties is also not available. Some network operators have operators to monitor conference availability and the undisrupted progress of the conference, the operators identifying and isolating hostile disruptive parties by sporadically listening in.

Pre-reserved conferences are available as DIAL-IN, DIAL-OUT or MIXED DIAL-IN/DIAL-OUT conferences. They are particularly useful for business customers. One disadvantage is that pre-reservation and conference planning have to be carried out manually and there is therefore no AD HOC availability.

For the purposes of completeness, reference should be made to conference services with Web-based operator interfaces (such as Siemens SURPASS WEBCONFER) and TERMINAL conferences, which are supported according to certain signaling standards. The former can be booked and controlled via internet access. The advantage of Web-based control with Status Display is limited by the disadvantage of internet access with the possible requirement of an additional terminal for the conference leader and lack of interaction with the conferees. TERMINAL conferences are for example conferences for audio, video and data, which depend on the terminal functions and are possible with the specifications of the H.323 Standard (or even the SIP Standard), with which conventional terminals cannot be used. A central bridge is superfluous here. Major conferences with a large number of participants are not possible due to the limited performance of the terminals. A further disadvantage is the increased bandwidth requirement between conferees.

Resources have to be made available in the network for all conference services. As conference services represent a cost-intensive investment for network operators, they are not made available to an unlimited degree in the network. This means increased control costs, and for interactions between the conference leader and the participants during the conference, the time and date of the conference have to be agreed, the availability of the conferees and the appropriate conference resources has to be established and participants have to be informed of the time and access authorization, to ensure the success of the conference.

Conferences which can be initiated on an AD HOC basis from experience have a control interface characterized by numerical sequence control of the telephony or a graphic control interface connected to a higher quality, intelligent, possibly additional, terminal, which set the limits for the sporadically immediate operability of any terminal. The system tones and announcements made available to the conferees only allow general conclusions about the progress and status of the conference. As far as pre-reserved conferences are concerned, in some circumstances significant manual interaction is required before the start of the conference. Such impediments make the deployment, use and success of conference solutions problematic.

### SUMMARY OF THE INVENTION

The invention relates to conference services for providing conference services such that operation and control is significantly simplified.

One advantage of the invention is that a control interface is provided between an announcement/dialog function and a conference management function and a voice recognition functionality is also provided. This considerably simplifies the preparation and operation/control of conference services. For example, the functional input via numerical sequences controlling the conference is no longer necessary, as the techniques based on the voice recognition functionality support a user-friendlier dialog between man and machine. Input can therefore be easily corrected by participants or operators. Essentially operation is simplified for all currently known conference types in TDM and packet-based network environments, in particular for DIAL-IN, DIAL-OUT, MIXED DIAL-IN/OUT, ETSI ADD-ON, PHONEMEET with/without operator monitoring, PRESET conference.

The conference functionality, in particular of conferences initiated on an AD HOC basis, is also decoupled from participant signaling and made available at remote level (i.e. more generally in further switching systems possibly belonging to competitor network operators). Additional devices with graphic operator interfaces are not necessary and operator input is minimized in respect of monitoring, booking and/or the procedural organization of conferences.

Another advantage of the invention is the positive impact on conference services. The ETSI ADD-ON conference functionality is not only available and easy to operate in the local switching center, but also in any TDM-based or packet-based network through the use of techniques based on (DTMF) voice recognition, to overcome the restrictions of participant signaling. Techniques based on voice recognition are advantageously used, when compressive coding methods are used particularly in packet-based networks, which do not guarantee disruption-free DTMF transmission. Booking and management processes for conference services can also be automated using corresponding IVR logic (Interactive Voice Response), such as recognition of disruptive parties and intercept initiation and control of follow-up activities by voice recognition mechanisms. Finally, simultaneous control of conference functionality by (DTMF) voice input by the conference leader and conferees is possible in an ongoing conference. This means that IVR dialogs can be forwarded for detailed status reports to individual or all conferees in an ongoing conference. Essentially ADD-ON, Dial-In, Dial-out, Phonemeet, MEET-ME and PRESET conferences can be achieved in combination with this concept.

### BRIEF DESCRIPTION OF THE DRAWINGS

The invention is described in more detail below using the figures below, in which:

FIG. 1 shows the basic relationships in the network.

FIG. 2 shows the interaction of the network elements during initiation and control of an active conference.

### DETAILED DESCRIPTION OF THE INVENTION

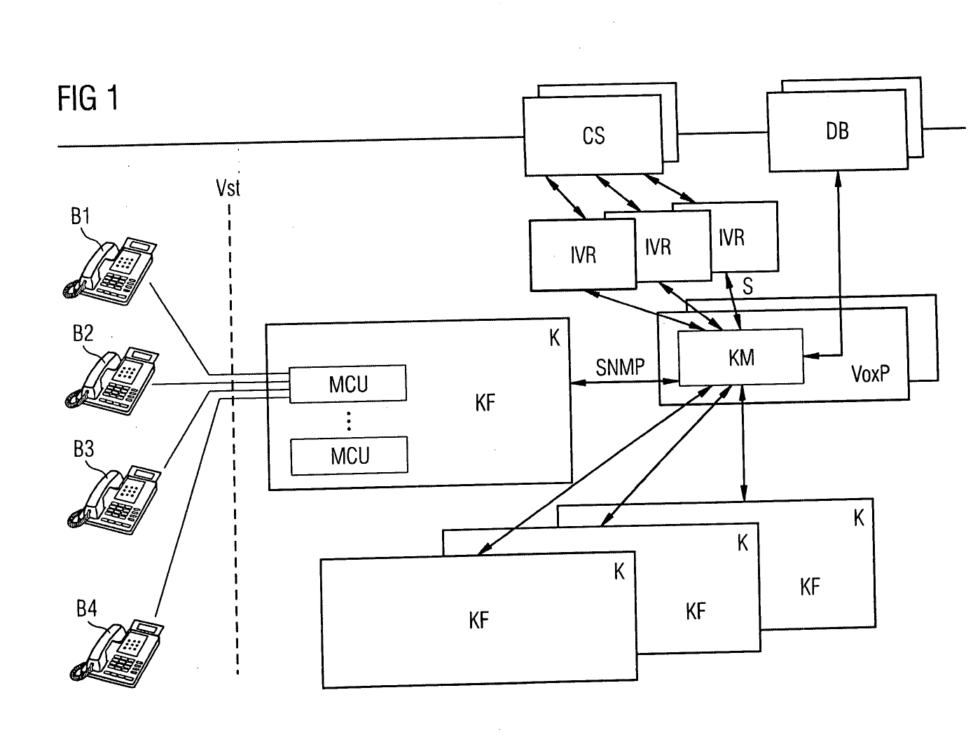

FIG. 1 shows the basic relationships according to the invention. According to one embodiment, there is a public TDM-based or packet-based, in particular IP-based network, in which at least one announcement and dialog function IVR, one conference management function KM and at least one conference function KF are available in order to provide user-friendly conference services.

FIG. 1 also shows, for example, 4 users B1 to B4, who wish to take part in a conference. The 4 conferees are served and controlled by a switching system Vst. FIG. 1 also shows a number of mutually independent conference systems K, in which the conference function KF is operating. Interface devices MCU can also be seen to be part of a conference system and these should be seen as the ends of the useful data streams from and to the conferees.

The conferees' useful data is switched through under the control of the switching center Vst and fed to these interface devices MCU. The useful data streams are also combined here.

The conference function KF essentially represents a conventional combined function of multiple input signals for audio or video signals. It also supports the distribution function for further information as well. The platform to be provided for this is characterized by telephony interfaces for adaptation to the network and signaling as well as by DSP-based combined functions for the audio stream and where appropriate further functions for controlling video output (e.g. Voice Activated Video Switching).

Conference features such as DIAL-IN or DIAL-OUT are supported in conference connections by the conference function KF and their descriptive data is supplied via a control interface to a conference management function KM. The latter can intervene in a controlling manner at any time in the configuration of an ongoing conference via this interface. The SNMP protocol is used for example as the protocol between the conference management function KM and the conference system K.

There are conferees, who are distinguished in that their input useful data stream is accessed before inclusion in the combined conference signal and fed to an announcement and dialog function IVR for a certain time for the purposes of monitoring for disruptive activity or to identify legitimate input controlling the conference (e.g. by the conference leader). An announcement and dialog function IVR can be permanently or temporarily assigned here via a control interface S between the announcement and dialog function IVR and the conference management function KM.

The announcement and dialog function IVR operates on at least one separate device or if necessary even collocated with the function KM described in more detail below on a device VoxP. It is used for dialog management with input recognition for the conference leader or the conferees, with DTMF input, menu-driven dialog or preferably keyword spotting in the natural dialog being used. The hardware platform required for the announcement and dialog function IVR is generally characterized due to the performance required in public networks by telephony interfaces, which undertake adaptation to the network technology and signaling, as well as by hardware and software, which carry out voice recognition tasks (e.g. DSPs, voice recognition algorithms).

The conference-specific dialog processes necessary for the announcement and dialog function IVR are stored appropriately on a content server CS, e.g. in the form of VoiceXML scripts, which are produced based on the conference configuration and give the complete dialog sequence for the IVR system.

FIG. 1 also shows a conference management function KM, which is configured as a purely software function and which operates on a device VoxP. This monitors and supports the status of the conference systems K and their ports generally and where necessary network-wide. A further important functionality is the reservation of conferences booked in advance, the prompt activation and monitoring/control of the conferences themselves and the generation of charge tickets, in particular with regard to the reservation of resources in the network. Booking data and charge data and where necessary error indices as well as traffic and statistical data are stored on a database server DB by the conference management function KM.

According to another embodiment of the invention, the announcement and dialog function IVR has a control interface S with the conference management function KM, with which it is able to output booking data for a conference or the initial conference parameters of an AD HOC conference to the conference management function for further processing. Conversely, the announcement and dialog function IVR receives information where necessary about the resource requirement, which can be covered at present or for the intended booking period from the conference management function and where necessary charge information for configuring the dialog with the party ordering the conference/the conference leader.

The conference management function has an overview of the availability of conference resources, if necessary network-wide, and can therefore in particular support and reserve conferences, which extend over a number of conference systems (cascading) because of their size or in the event of resource shortages.

Finally, for reasons of fail-safety, the database server DB, content server CS, conference management function KM, announcement and dialog function IVR and the conference function KF are at least duplicated. The functions do not necessarily have to be set up on different hardware platforms. The IVR function and KM function in particular can be set up on different hardware platforms.

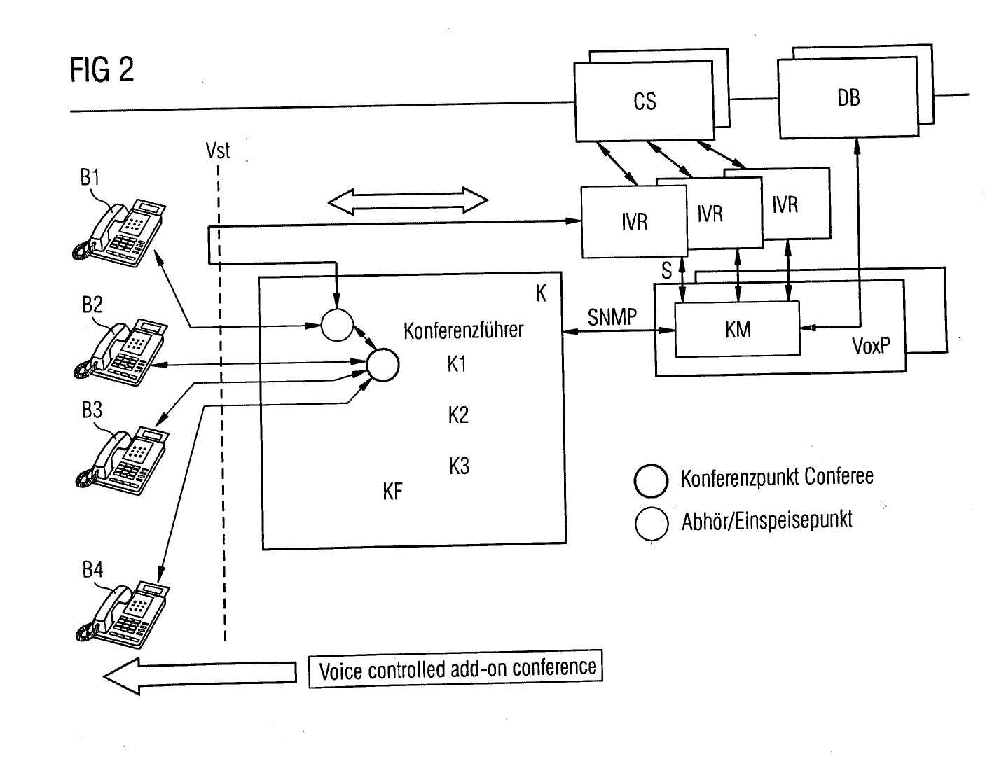

FIG. 2 shows the interaction of the network elements during an active conference as an application of the method according to the invention.

An ETSI ADD-ON conference, for example, is assumed here. This is a spontaneously activatable major conference. With the method according to the invention, the conference features of the ETSI ADD-ON conference can be taken away from a local switching center and supplied in a much more user-friendly manner. This requires the conference leader to have explicitly subscribed to the service or to have implicit authorization for the service through their telephony profile. A functional limitation is that the conference cannot be set up from any existing party connection without a further request, i.e. the conference leader has to intend to call a conference when initiating the connection.

If this condition exists, the conference leader calls a service call number of the network operator, resulting in connection to an announcement/dialog function IVR, which verifies the leader's service entitlement and identifies the initially known conference data preferably in the natural dialog. The announcement/dialog function IVR verifies the initially requested data on the basis of available conference resources by accessing the conference management function KM. If the required resources are available, the initial conference starts, where necessary after a charge notification has been displayed and consent has been received for conference activation. This requires the conference parameters to be forwarded to the conference management function. The availability of the resources is verified here if necessary during the course of the dialog using the conference management function KM and the conference resources can expediently be booked provisionally by the conference management function. The connection required to define the initial conference with the announcement and dialog function IVR is canceled after a corresponding notification announcement has been displayed.

Once the conference parameters have been forwarded to the conference management function, the initial conference starts via dial-out from at least one of the conference systems. The conference leader here is a designated first conferee and receives a corresponding notification announcement, until the next conferee is included. Further conferees are each included with corresponding notification tones or announcements. The initial conference parameters can also contain DIAL-IN authorized user addresses, thereby allowing a combination of ADD-ON and MEET-ME conferences.

To control the conference further, the conference leader, designated as the first conferee, is connected with their input useful data stream from the start of the conference to a specific announcement and dialog function IVR at the same time. This searches the input stream of the conference leader for specific key words (such as “conference operator”) or a certain DTMF input. If one such is detected, the announcement and dialog function IVR activates the start of a dialog with the conference leader to identify new wishes on the part of the conference leader arising during the course of the conference. Such wishes may for example be the connection of a further conferee, the isolation or disconnection of a conferee, wishes relating to image configuration/videoconference mode, data input, formation of discussion groups, moving the conference leader between discussion groups in the conference, etc.

In the simplest instance the conference leader's dialog can be heard by the other conferees, which has the advantage that said conferees are kept constantly informed about the progress of the conference. If this is not required, the announcement and dialog function IVR uses the control interface of the conference function KF to disconnect the conference leader from the conference for the duration of the IVR dialog for conference management purposes. Disconnected conferees can be shown a corresponding notification announcement.

The conference ends when the conference leader terminates the connection or with IVR dialog to terminate the conference, where necessary displaying the accrued charges, which can be stored via the conference management function for each section of the conference in the database.

Further developments of the method according to the invention in this embodiment are the passing of conference leadership to one of the conferees or control of the conference function (e.g. of the video signal to a conferee) by the conferees themselves, in the same way as the conference is controlled overall by the conference leader, in other words in particular by a search by the announcement and dialog function IVR and preferably in the natural dialog.

A further feature according to the invention in this embodiment is the automatic forwarding (CALL TRANSFER) of the first connection of the conference initiator from the announcement/dialog function IVR to the intercept/entry point of the conference leader of the conference function KF under the control of the conference management function KM. This allows the conference leader to set up the AD HOC conference in a manner which is user-friendlier than the DIAL OUT procedure described above, in which the connection initiating the conference service is terminated.

What is claimed is:

1. A method for controlling conferences, with at least one announcement/dialog function, and at least one conference function, comprising:
starting a conference with dialog of a conference leader with an announcement/dialog function under control of a conference management function;
monitoring a data stream of the conference leader for keywords or tones by the announcement/dialog function to control the conference; and
whenever a keyword or tone is identified, the dialog is started between the conference leader and the announcement/dialog function.

2. The method according to claim 1, wherein the conference commences when a service call number is dialed by the conference leader, such that a connection is set up between the conference leader and the announcement/dialog function, such that the dialog takes place to exchange characteristic data, and the conference is initiated based on service entitlement of the conference leader and available conference resources, and inclusion of additional conferees is executed under control of the conference management function and in the dialog of the announcement/dialog function with the conference leader.

3. The method according to claim 1, wherein the dialog between the announcement/dialog function and the conference leader is DTMF-controlled.

4. The method according to claim 1, wherein the dialog between the announcement/dialog function and the conference leader takes place using a keyword spotting voice recognition function.

5. The method according to claim 1, wherein the keywords monitored by the announcement/dialog function are of a spoken nature and/or are configured as DTMF input.

6. The method according to claim 1, wherein identifying a keyword in the dialog between the conference leader and the announcement/dialog function enables further conference features to be optionally initiated, including at least one of an additional conferee, isolation or disconnection of a conferee, influencing of image configuration/video conference mode, data input, formation of discussion groups, and moving the conference leader between discussion groups in the conference.

7. The method according to claim 1, wherein the dialog between the conference leader and the announcement/dialog function is optionally suppressed for other conferees by disconnecting the conference leader from the conference via the control interface with the conference function for the duration of the dialog.

8. The method according to claim 1, wherein the conference ends when the conference leader terminates the connection or via the dialog between the conference leader and the announcement/dialog function, with an option of displaying accrued charges and/or the accrued charges being stored via the conference management function for each section of the conference in a database.

9. The method according to claim 1, wherein the conference leader can be passed to one of the conferees or the conference function can be controlled by the conferees by means of dialog with the announcement/dialog function.

10. The method according to claim 1, wherein details of the dialog with the conference leader and conferees are stored as VoiceXML scripts on at least one content server accessible to the dialog functions.

11. The method according to claim 1, wherein the conference management function identifies availability of the conference function and the announcement and dialog function and influences progress of the dialogs with the conference leader and conferees accordingly via the control interface.

12. The method according to claim 1, wherein the conference management function, the recognition function and the conference function are at least duplicated on at least two different hardware platforms.

13. The method according to claim 1, wherein the conference management function is configured to intervene during control of a conference and is configured to activate the announcement and dialog function to inform and interrogate the conferees.

14. The method according to claim 1, wherein for entry into conference status, connection of the conference initiator is automatically forwarded from the announcement/dialog function to a conference function.

15. A device for controlling conferences, with at least one dialog function and at least one conference function, which operate on at least one conference system, comprising a control interface provided between the announcement/dialog function and a conference management function, which initiates at least one conference via the conference management function and controls progress based on voice and/or tone signals of one or more conferees occurring in a data stream and in conjunction with at least one announcement/dialog function.
